(19) United States
(12) Patent Application Publication
(10) Pub. No.: US 2026/0058321 A1
(43) Pub. Date: Feb. 26, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(72) Inventors: Kotaro TAKADA, Osaka (JP); Osamu NAKAYAMA, Osaka (JP); Katsushi MIYAZAKI, Osaka (JP); Daiki TSUJI, Osaka (JP); Takami IZAWA, Kanagawa (JP); Masayuki NAKAI, Kanagawa (JP); Yasuhiro YANAGIHARA, Kanagawa (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(21) Appl. No.: 19/117,738

(22) PCT Filed: Sep. 19, 2023
(86) PCT No.: PCT/JP2023/033887

§ 371 Date: Apr. 2, 2025

(30) Foreign Application Priority Data
Oct. 6, 2022 (JP) 2022-161745

(51) Int. Cl. H01M 50/503

(52) U.S. Cl. CPC H01M 50/503

(57) ABSTRACT

A wiring module includes detection terminals, detection wires, first and second housing portions, a third housing portion receiving a curved portion and including a corner portion on an inner circumferential side and including two third side walls, two outer holding pieces corresponding to two end portions of the curved portion and protruding from an outer circumferential side toward the inner circumferential side and holding the curved portion, and two inner holding pieces corresponding to the two end portions of the curved portion and protruding from the inner circumferential side toward the outer circumferential side and holding the curved portion. The inner holding pieces at least protrude from one of the two third side walls on the inner circumferential side to a tangent line with respect to the corner portion, the tangent line extending at an angle of 45° with respect to the one of the two third side walls.

### TECHNICAL FIELD

The present disclosure relates to a wiring module.

### BACKGROUND ART

A wiring module that is installed in a vehicle such as an electric automobile or a hybrid automobile has been known. A battery wiring module that is disclosed in Japanese Unexamined Patent Application Publication No. 2013-161566 (Patent Document 1 described below) has been known as an example of such a wiring module. The battery wiring module includes busbars each of which connects electrode terminals of a pair of battery cells that are adjacent to each other, detection terminals connected to the busbars, detection wires connected to electric wire connection portions of the detection terminals, busbar housing portions in which the busbars are disposed, and an electric wire housing groove in which the detection wires are disposed. The electric wire housing groove includes a pair of groove walls and a bottom portion and extends along an arrangement direction in which the busbar housing portions are arranged. A pair of electric wire holding pieces 36A, 36B for holding the detection wire are formed on and protrude from the groove walls of the electric wire housing groove. The groove wall of the pair of groove walls that is closer to the busbar housing portion includes a cutout portion through which the detection wire extends into the electric wire housing groove from the busbar housing portion side.

Such a battery wiring module has following problems. The detection wire extending from the busbar housing portion into the electric wire housing groove through the cutout portion is routed as follows. The detection wire is contacted with the groove wall that is on an opposite side from the busbar housing portion and curved and extends laterally (along a direction in which the electric wire housing groove extends) and is routed along the groove wall by a reaction force caused by the curving. However, at the curved portion of the detection wire may be out of the electric wire housing groove due to the reaction force.

In this respect, in the battery wiring module described above, the electric wire holding piece 36B protrudes from the groove wall that is on an opposite side from the busbar housing portion. A gap for entry of the detection wire that is formed near a distal end of the electric wire holding piece 36B is formed to be closer to the busbar housing portion from the center line with respect to the width direction of the electric wire housing groove. With such a configuration, the curved portion of the detection wire is less likely to be out of the electric wire housing groove.

In the above battery wiring module, as illustrated in FIG. 3 of Patent Document 1, the busbar housing portion and the cutout portion are connected via a barrel holding portion. The barrel holding portion holds the electric wire connection portion of the detection wire. The barrel holding portion extends vertically to the electric wire housing groove. The electric wire housing groove and the busbar housing portion are connected via the barrel holding portion and the cutout portion. A pair of electric wire holding pieces 34A, 34B are at upper end edges of the cutout portion and opposite each other. The electric wire holding pieces 34A, 34B are provided such that the detection wire extending from the barrel holding portion is not out of the cutout portion. One of the pair of electric wire holding pieces 34A, 34B that is closer to the curved portion of the detection wire (on a left side in FIG. 3 and referred to on the left side hereinafter) is defined as the left electric wire holding piece 34A and another one on the opposite side from the curved portion side (on a right side in FIG. 3 and referred to on the right side hereinafter) is defined as the right electric wire holding piece 34B.

### PRIOR ART

### Patent Document

Patent Document 1: Japanese Unexamined Patent Application Publication No. 2013-161566

### SUMMARY OF THE INVENTION

### Problem to be Solved by the Invention

In the above battery module, the left electric wire holding piece 34A is closest to a corner portion, which is between the cutout portion and the electric wire housing groove, and the electric wire holding piece 36A in the electric wire housing groove is farther away from the corner portion than the left electric wire holding piece 34A is. A connector may be arranged on other end portion of the detection wire opposite from one end portion thereof close to the detection terminal. In such a configuration, when the connector is fitted to a target connector, the detection wire is strongly pulled and curved along the corner portion and routed with a shortest distance. The detection wire is held by the left electric wire holding piece 34A at a portion thereof on the cutout portion side with respect to the curved portion; however, there is no electric wire holding portion near a portion of the detection wire on the electric wire housing groove side with respect to the curved portion. Therefore, the curved portion of the detection wire may be out of the electric wire housing groove.

The present disclosure was made in view of the above circumstances. An object is to suppress protrusion of a curved portion of a detection wire out of a housing portion.

### Means for Solving the Problem

A wiring module according to the present disclosure is to be coupled to a battery group including batteries each of which has a pair of electrodes and that are arranged. The wiring module includes detection terminals that are connected to the electrodes or connected to the electrodes via a connection member, detection wires each of which includes a first wire portion that is connected to one of the detection terminals and extends in a vertical direction perpendicular to an arrangement direction in which the batteries are arranged, a second wire portion that extends in the arrangement direction in which the batteries are arranged, and a curved portion that connects the first wire portion and the second wire portion and is curved from the vertical direction to the arrangement direction, a first housing portion in which the first wire portion is arranged, a second housing portion in which the second wire portion is arranged, a third housing portion in which the curved portion is arranged and that includes a corner portion on an inner circumferential side with respect to the curved portion and connects the first housing portion and the second housing portion and has an L-shape and includes a pair of third side walls on two sides of the third housing portion, a pair of outer holding pieces provided corresponding to two end portions of the curved portion, respectively, the pair of outer holding pieces protruding from an outer circumferential side toward the inner circumferential side with respect to the curved portion and holding the curved portion, and a pair of inner holding pieces provided corresponding to the two end portions of the curved portion, respectively, the inner holding pieces protruding from the inner circumferential side toward the outer circumferential side with respect to the curved portion and holding the curved portion. The pair of inner holding pieces at least protrude from one of the pair of third side walls of the third housing portion that is on the inner circumferential side to a tangent line with respect to the corner portion, the tangent line extending at an angle of 45° with respect to the one of the pair of third side walls.

### Effects of the Invention

According to the present disclosure, the curved portion of the detection wire is less likely to be out of a housing portion.

### BRIEF DESCRIPTION OF THE DRAWINGS

FIG. 1 is a perspective view of a battery module according to a first embodiment.

FIG. 2 is a front view of the battery module.

FIG. 3 is a perspective view of a front portion of a battery stack member.

FIG. 4 is a perspective view of a portion of a laminated type battery.

FIG. 5 is a cross-sectional view along A-A line in FIG. 2.

FIG. 6 is a front view illustrating a curved portion arranged in a third housing portion with a detection wire having an extra length portion.

FIG. 7 is a front view illustrating the detection wire arranged in a first housing portion and the third housing portion.

FIG. 8 is a front view illustrating the curved portion arranged in the third housing portion with the detection wire being pulled.

FIG. 9 is a cross-sectional view along B-B line in FIG. 8.

FIG. 10 is a cross-sectional view along C-C line in FIG. 8.

FIG. 11 is an enlarged view of FIG. 8 illustrating a pair of inner holding pieces being in a closest position with respect to a corner portion.

### MODES FOR CARRYING OUT THE INVENTION

### Description of Embodiments according to the Present Disclosure

First, embodiments according to the present disclosure will be listed and described.

(1) A wiring module according to the present disclosure is to be coupled to a battery group including batteries each of which has a pair of electrodes and that are arranged. The wiring module includes detection terminals that are connected to the electrodes or connected to the electrodes via a connection member, detection wires each of which includes a first wire portion that is connected to one of the detection terminals and extends in a vertical direction perpendicular to an arrangement direction in which the batteries are arranged, a second wire portion that extends in the arrangement direction in which the batteries are arranged, and a curved portion that connects the first wire portion and the second wire portion and is curved from the vertical direction to the arrangement direction, a first housing portion in which the first wire portion is arranged, a second housing portion in which the second wire portion is arranged, a third housing portion in which the curved portion is arranged and that includes a corner portion on an inner circumferential side with respect to the curved portion and connects the first housing portion and the second housing portion and has an L-shape and includes a pair of third side walls on two sides of the third housing portion, a pair of outer holding pieces provided corresponding to two end portions of the curved portion, respectively, the pair of outer holding pieces protruding from an outer circumferential side toward the inner circumferential side with respect to the curved portion and holding the curved portion, and a pair of inner holding pieces provided corresponding to the two end portions of the curved portion, respectively, the inner holding pieces protruding from the inner circumferential side toward the outer circumferential side with respect to the curved portion and holding the curved portion. The pair of inner holding pieces at least protrude from one of the pair of third side walls of the third housing portion that is on the inner circumferential side to a tangent line with respect to the corner portion, the tangent line extending at an angle of 45° with respect to the one of the pair of third side walls.

The angle may not necessarily be 45° but may have a tolerance of ±5°. In such a configuration, the tangent line may extend with respect to the corner portion with an angle range from 40° to 50°. The third side wall may not necessarily protrude to the tangent line but may protrude at least to a position of the tangent line or may protrude further from the position of the tangent line.

The detection wire extends from the first housing portion to the second housing portion via the third housing portion and the curved portion is curved along the third side wall on the outer circumferential side from the upper-bottom direction to the right-left direction due to a reaction force created in the curved portion. However, the curved portion may be out of the third housing portion due to the reaction force. With the wiring module including the pair of outer holding pieces corresponding to the two end portions of the curved portion, respectively, the curved portion of the t detection wire is less likely to be out of the housing portion.

A connector may be provided on other end of two ends of the detection wire that is an opposite end side from the detection terminal and when the detection wire is strongly pulled at the time of fitting of the connector to a target connector, the curved portion of the detection wire is curved along the corner portion of the third housing portion and the detection wire is arranged with a shortest route. In this respect, the pair of inner holding pieces are provided corresponding to the two end portions of the curved portion, respectively. The pair of inner holding pieces protrude from one of the third side walls on the inner circumferential side to the tangent line extending with respect to the corner portion at the angle of 45° with respect to the one of the pair of third side walls. With such a configuration, the curved portion of the detection wire is less likely to be out of the housing portion.

(2) The first housing portion preferably includes a pair of first side walls that are, respectively, continuous to the pair of third side walls. A pair of first holding pieces are preferably on the pair of first side walls so as to be opposite each other and the pair of first holding pieces hold the first wire portion. A third space formed between one of the pair of outer holding pieces and one of the pair of inner holding pieces that are close to the first housing portion in the third housing portion and are opposite each other and a first space between the pair of first holding pieces preferably have a same dimension and are on a same straight line extending in the vertical direction.

The same dimension may not be necessarily a strictly same dimension but means that the first space and the third space overlap with at least 50% of the entire dimensions of the spaces with a vertical view. The spaces may have dimensions such that the detection wire can be arranged in the first housing portion and the third housing portion with extending straight.

With the third space and the first space having the same dimension and being on the same straight line, the detection wire can be arranged and routed in the first housing portion and the third housing portion with the detection wire extending straight in the vertical direction. Therefore, the routing operation of the detection wire can be improved.

The pair of first holding pieces preferably have distal ends having a mountain shape and the first space is formed between the distal ends of the pair of first holding pieces and the first space is preferably a smallest space between the pair of first holding pieces. The distal end of the one of the pair of outer holding pieces and the distal end of the one of the pair of inner holding pieces preferably have a mountain shape and the third space is formed between the distal end of the one of the pair of outer holding pieces and the distal end of the one of the pair of inner holding pieces close to the first housing portion in the third housing portion and the third space is preferably a smallest space between the distal ends of the one of the pair of outer holding pieces and the one of the pair of inner holding pieces.

With the distal end of the outer holding piece and the distal end of the inner holding piece having a mountain shape, the smallest space through which the detection wire hardly passes becomes smaller and therefore, the workability of routing the detection wire is further improved.

### Details of Embodiments according to the Present Disclosure

Embodiments according to the present disclosure will be described. The present disclosure is not limited to the embodiments. All modifications within and equivalent to the technical scope of the claimed invention may be included in the technical scope of the present invention.

### Embodiment

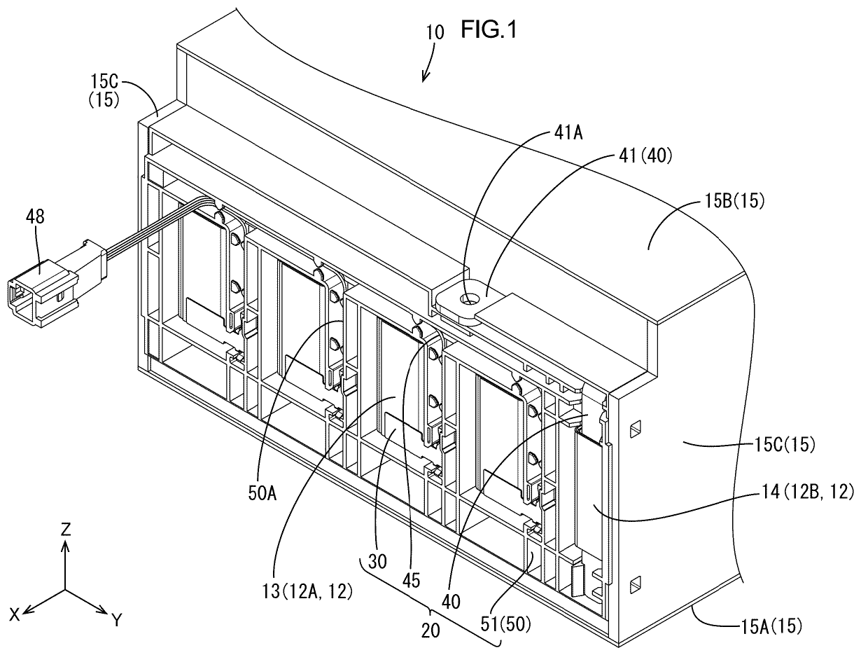

An embodiment of the present disclosure will be described with reference to FIGS. 1 to 11. A battery module 10 including a wiring module 20 according to this embodiment is installed in a vehicle as a power source for driving a vehicle such as an electric automobile or a hybrid automobile. In the following description, regarding components having the same configuration, some of the components may be indicated by reference signs and others may not be indicated by the reference signs. In the following description, it is considered that an X arrow, a Y arrow, and an Z arrow point the front side, the left side, and the upper side, respectively. In this embodiment, an upper-bottom direction is one example of a vertical direction and a right-left direction is one example of an arrangement direction.

### Battery Stack Member

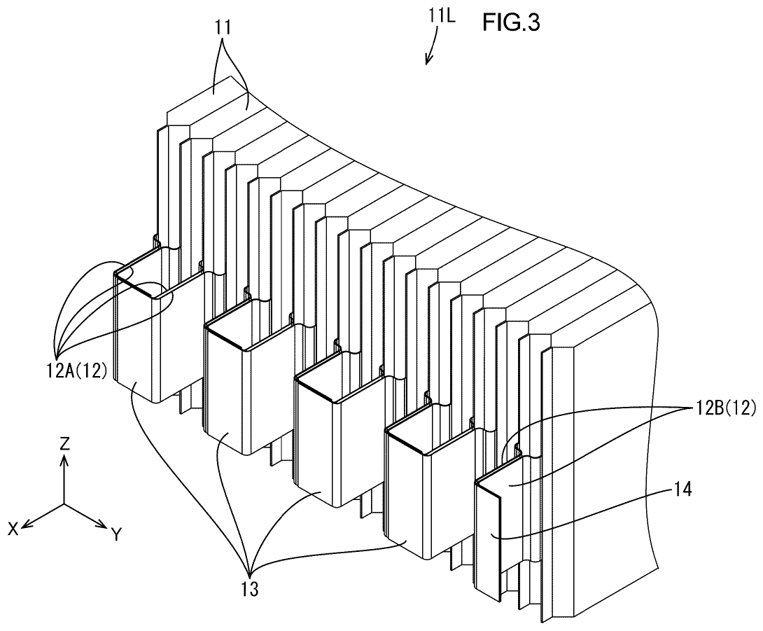

The battery module 10 includes a battery stack member 11L illustrated in FIG. 3 and the wiring module 20 that is attached to the battery stack member 11L. As illustrated in FIG. 1, the battery module 10 of this embodiment further includes a casing 15 that covers the battery stack member 11L from four sides, that are from upper, lower, right, and left sides. The casing 15 includes a bottom portion 15A that is placed on a lower surface side of the battery stack member 11L, a ceiling portion 15B that is placed on an upper surface side of the battery stack member 11L, and a pair of side portions 15C that connect the bottom portion 15A and the ceiling portion 15B on the right and left sides.

### Laminated Type Battery, Electrode Lead

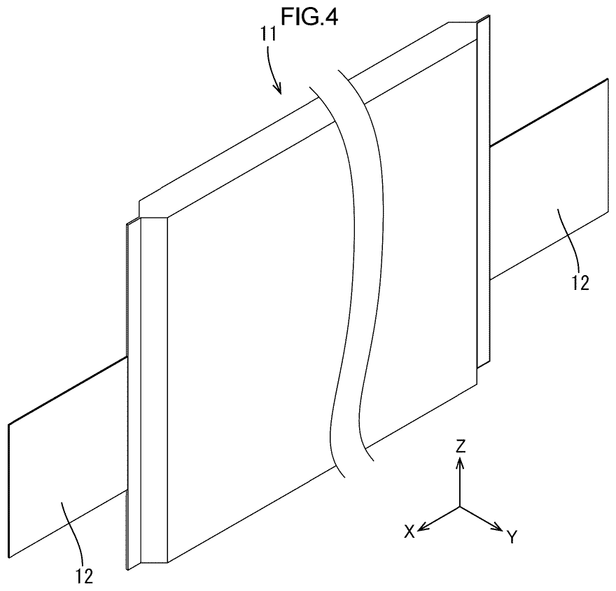

As illustrated in FIG. 3, the battery stack member 11L includes laminated type batteries 11 (eighteen laminated type batteries in this embodiment) that are stacked in the right-left direction. Only a front section of the battery stack member 11L is illustrated in FIG. 3. As illustrated in FIG. 4, the laminated type battery 11 has a flat shape that is elongated in a front-rear direction and has a small thickness in the right-left direction. The laminated type batteries 11 include power storage elements (not illustrated) therein. The laminated type battery 11 includes a pair of electrode leads 12. The pair of electrode leads 12 are on front and rear sides of the laminated type battery 11, respectively, and protrude from the laminated type battery 11 in opposite directions. The pair of electrode leads 12 have a plate shape and have opposite polarities.

### Connection Portion

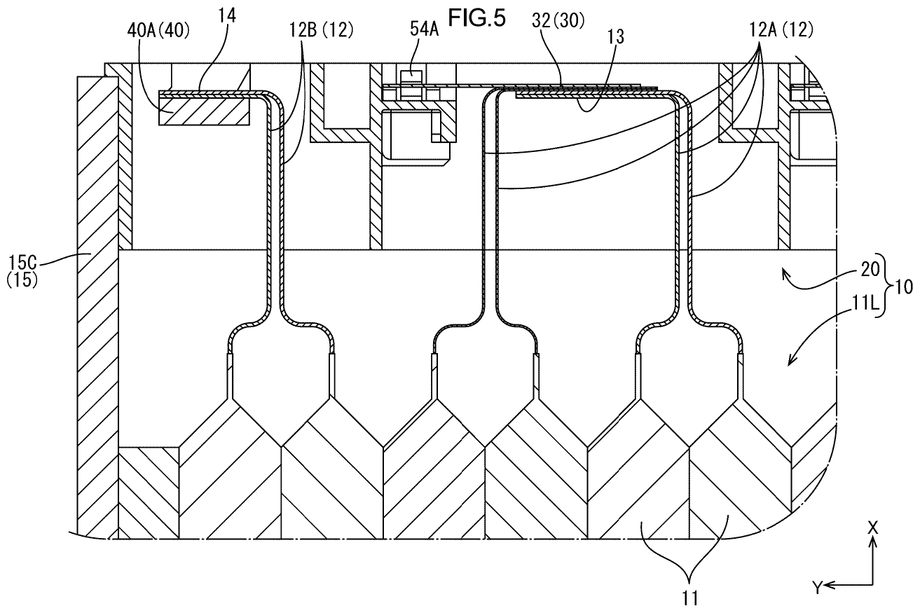

As illustrated in FIGS. 3 and 5, the battery stack member 11L includes connection portions 13. The four electrode leads 12 of the laminated type batteries 11 that are arranged adjacent to each other in the right-left direction are electrically connected at the connection portion 13. The four electrode leads 12 are bent leftward or rightward at a right angle and overlapped and connected with laser welding and thus, the connection portions 13 are formed. Some of the electrode leads 12 that are configured as the connection portions 13 are defined as connection electrode leads 12A. Among the four connection electrode leads 12A, the two connection electrode leads 12A on the right side and the two connection electrode leads 12A on the left side have opposite polarities. For example, the two connection electrode leads 12A on the right side have a positive polarity and the two connection electrode leads 12A on the left side have a negative polarity. Therefore, in the battery stack member 11L, the two laminated type batteries 11 that are connected in parallel are connected series via the connection portion 13. As illustrated in FIG. 3, the battery stack member 11L includes four connection portions 13 on a front section. The battery stack member 11L includes four connection portions 13 on a rear section, although it is not illustrated.

Since a process of forming the connection portions 13 includes a process of bending the electrode leads 12 and a process of laser welding, tolerances of the connection portions 13 (and the connection electrode leads 12A) with respect to the front-rear direction are particularly likely to become large. For example, in this embodiment, the tolerance of the connection portion 13 (and the connection electrode lead 12A) with respect to the front-rear direction is a large value compared to a thickness of the electrode lead 12 (0.2 mm, 0.4 mm).

As illustrated in FIGS. 3 and 5, the battery stack member 11L includes an output portion 14 on a left edge portion of a front section. The battery stack member 11L also includes the output portion 14 on a right edge portion of a front section, although it is not illustrated. Among the electrode leads 12, the two electrode leads 12, which are not configured as the connection portion 13, are connected and configured as the output portion 14. The electrode leads 12 that are configured as the output portion 14 are defined as output electrode leads 12B. The two output electrode leads 12B that are configured as the output portion 14 have a same polarity. The output portion 14 is configured as a positive polarity or a negative polarity of the whole battery stack member 11L. Namely, with the output portion 14 on the front section having a positive polarity of the whole battery stack member 11L, the output portion 14 on the rear section has a negative polarity of the whole battery stack member 11L.

### Wiring Module

As illustrated in FIG. 1, the wiring module 20 of this embodiment includes detection terminals 30 that are connected to the connection electrode leads 12A, a busbar 40 that is connected to the output electrode leads 12B, detection wires 45 that are connected to the detection terminals 30, and a protector 50 that holds the detection terminals 30, the busbar 40, and the detection wires 45. In the following, a configuration of the wiring module 20 that is arranged on a front side of the battery module 10 will be described in detail. The wiring module 20 arranged on a rear side of the battery module 10, which is not illustrated, has a configuration similar to that of the wiring module 20 arranged on the front side of the battery module 10.

### Busbar

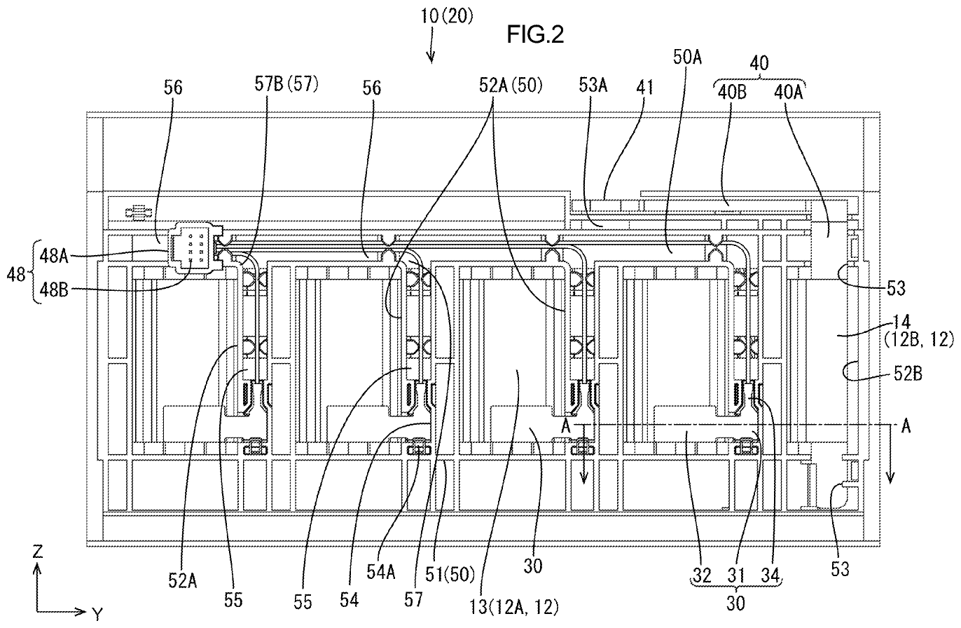

The busbar 40 has a plate shape and is made by processing a metal plate having electrically conductive properties. As illustrated in FIG. 2, the busbar 40 includes a first portion 40A that extends in an upper-bottom direction and a second portion 40B that is connected to an upper end portion of the first portion 40A. The first portion 40A has a flat shape having a small thickness in the front-rear direction. The second portion 40B extends rightward from the upper end portion of the first portion 40A and has a flat shape having a small thickness in the upper-bottom direction. The busbar 40 is held in a busbar holding portion 53 of the protector 50 and a middle portion of the first portion 40A in the upper-bottom direction is connected to the output electrode lead 12B. A busbar side connection portion 41 is at a right end portion of the second portion 40B.

As illustrated in FIG. 1, the busbar side connection portion 41 has a through hole 41A through which a bolt is inserted. An external connection terminal, which is not illustrated, is disposed on the busbar side connection portion 41 and fixed to the busbar side connection portion 41 with the bolt. Accordingly, the busbar side connection portion 41 is electrically connected to the external connection terminal. The external connection terminal is used for connecting the battery module 10 and an external device, which is not illustrated.

### Detection Wire

The detection wire 45 includes a core wire and an insulating sheath that covers the core wire. One end of each detection wire 45 is connected to the detection terminal 30 that detects a voltage of each laminated type battery 11. Other ends of the detection wires 45 are collectively connected to a connector 48. The detection wires 45 are routed in a routing recess portion 50A of the protector 50 and in predetermined positions. Detection wires in claims include a device that detects a current and temperature of each laminated type battery 11 and electric wires connected to a controller in addition to the electric wires connected to the detection terminals 30.

As illustrated in FIG. 2, the connector 48 includes a housing 48A that is made of synthetic resin having insulating properties and a male terminal 48B arranged in the housing 48A. The connector 48 is to be fitted to a target connector (not illustrated) including a female terminal. The target connector is connected to an external ECU (electronic control unit) via an electric wire, which is not illustrated. The ECU has a known configuration including a microcomputer and components and has a function of detecting a voltage, a current, and a temperature of each laminated type battery 11 and has a function of controlling charging and discharging of each laminated type battery 11.

### Detection Terminal

The detection terminal 30 is formed by processing an electrically conductive metal plate. As illustrated in FIG. 2, the detection terminal 30 includes a body portion 31, a connection portion 32 extending rightward from the body portion 31, and an electric wire connection portion 34 extending upward from the body portion 31. The body portion 31 is a right portion of the detection terminal 30 and has a rectangular front view shape. The body portion 31 is arranged in a terminal housing portion 54 such that a plate thickness direction thereof corresponds to the front-rear direction. A terminal holding portion 54A is in a lower end portion of the terminal housing portion 54. The terminal holding portion 54A holds the detection terminal 30 in the terminal housing portion 54.

The connection portion 32 has an elongated rectangular shape extending in the right-left direction and is on a same plane as the body portion 31. The connection portion 32 extends upward and downward than the body portion 31 in the upper-bottom direction. As illustrated in FIG. 5, the connection portion 32 is configured to be surface-contacted with a portion of the connection portion 13 or a portion of the connection electrode lead 12A that is configured as the connection portion 13. Namely, the detection terminal 30 is not for connecting the adjacent connection electrode leads 12A but for connecting the connection electrode leads 12A that are previously connected (the connection portion 13) and the detection wire 45. Therefore, the dimension of the connection portion 32 with respect to the upper-bottom direction may be smaller than the dimension of the connection electrode leads 12A with respect to the upper-bottom direction.

### Protector

As illustrated in FIG. 1, the protector 50 is made of synthetic resin having insulating properties and has a plate shape. The protector 50 includes a protector body 51 that is positioned with respect to the casing 15 (and the battery stack member 11L). As illustrated in FIG. 2, electrode housing recess portions 52 are arranged in the right-left direction in a middle section of the protector body 51 with respect to the upper-bottom direction. The electrode housing recess portions 52 are through the front-rear direction and have an elongated rectangular shape extending in the upper-bottom direction. The electrode housing recess portion 52 includes connection electrode housing recess portions 52A that receive the connection portion 13 and the connection electrode leads 12A and an output electrode housing recess portion 52B that receives the output electrode lead 12B and the output portion 14.

As illustrated in FIG. 2, the output electrode housing recess portion 52B includes busbar holding portions 53, which hold the busbar 40, on upper and lower portions thereof. A bolt fixing portion 53A for fixing the busbar 40 with a screw is on a right side of the upper busbar holding portion 53. The terminal housing portion 54 in which a portion of the detection terminal 30 is arranged is on a lower left side of the connection electrode housing recess portion 52A. The terminal housing portion 54 is recessed rearward from the protector body 51.

### Routing Recess Portion

The routing recess portion 50A is recessed rearward from the protector body 51 similar to the terminal housing portion 54. The inner space of the routing recess portion 50A is continuous to the inner space of the terminal housing portion 54. The detection wire 45 extending from the detection terminal 30 that is arranged in the terminal housing portion 54 is arranged in the routing recess portion 50A. The routing recess portion 50A includes a first housing portion 55, a second housing portion 56, and a third housing portion 57. The first housing portion 55 is continuous and extend upward in the upper-bottom direction from the terminal housing portion 54. The second housing portion 56 is on an upper side of the first housing portion 55 and extends in the right-left direction. The third housing portion 57 connects the first housing portion 55 and the second housing portion 56.

The first housing portion 55 is adjacent to and on the right side of the connection electrode housing recess portion 52A. The second housing portion 56 is adjacent to and on an upper side of the connection electrode housing recess portion 52A. The third housing portion 57 has a L-shape and connects an upper end portion of the first housing portion 55 and a left end portion of the second housing portion 56 that is on an upper right side of the first housing portion 55. A corner portion 57B is on an upper left side of the connection electrode housing recess portion 52A and on an inner circumferential side of a curved portion 45C, which will be described next.

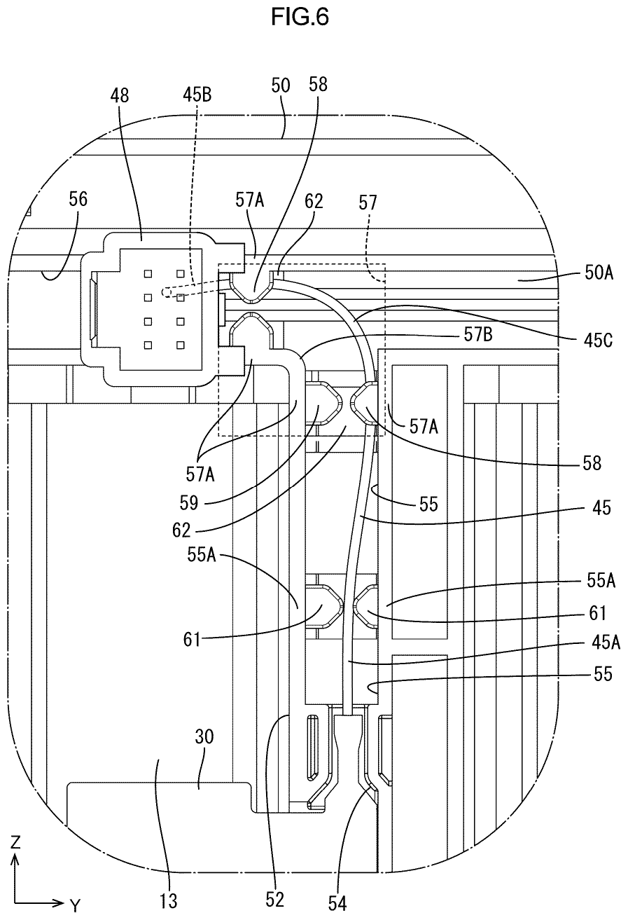

The detection wire 45 includes a first wire portion 45A, a second wire portion 45B, and the curved portion 45C. The first wire portion 45A is connected to the detection terminal 30 and extends in the upper-bottom direction that is a direction vertical to an arrangement direction in which the laminated type batteries 11 are arranged. The second wire portion 45B extends in the right-left direction that is the arrangement direction in which the laminated type batteries 11 are arranged. The curved portion 45C connects the first wire portion 45A and the second wire portion 45B and is curved from an end of the first wire portion 45A extending in the upper-bottom direction toward an end of the second wire portion 45B extending in the right-left direction. The detection wire 45 includes an extra length portion that is necessary when the detection wire 45 is routed in the routing recess portion 50A or when the connector 48 is fitted to a target connector. Therefore, as illustrated in FIG. 6, a reaction force is created in the curved portion 45C and therefore, the curved portion 45C of the detection wire 45 is arranged along an outer circumferential portion of the third housing portion 57.

The first wire portion 45A of the detection wire 45 is arranged in the first housing portion 55, the second wire portion 45B of the detection wire 45 is arranged in the second housing portion 56, and the curved portion 45C of the detection wire 45 is arranged in the third housing portion 57. More in detail, a L-shaped section surrounded by a dotted line illustrated in FIG. 6 is defined as the third housing portion 57 and an area where the curved portion 45C is arranged is defined as the third housing portion 57.

Two side portions of the third housing portion 57 are defined by a pair of third side walls 57A. A pair of third side walls 57A on a lower end side are opposite each other with respect to the right-left direction. A pair of third side walls 57A on a right end side are opposite each other with respect to the upper-bottom direction. Among the pair of third side walls 57A on the lower end side, the third side wall 57A on the right side is defined as the third side wall 57A on an outer circumferential side and the third side wall 57A on the left side is defined as the third side wall 57A on an inner circumferential side. Similarly, among the pair of third side walls 57A on the right end side, the third side wall 57A on the upper side is defined as the third side wall 57A on the outer circumferential side and the third side wall 57A on the lower side is defined as the third side wall 57A on the inner circumferential side.

A pair of outer holding pieces 58 and a pair of inner holding pieces 59 are formed on the two end portions of the third housing portion 57. The pair of outer holding pieces 58 are provided corresponding to the two end portions of the curved portion 45C, respectively. The outer holding pieces 58 protrude from the outer circumferential side toward the inner circumferential side with respect to the curved portion 45C and hold the curved portion 45C from the front side. The pair of inner holding pieces 59 are provided corresponding to the two end portions of the curved portion 45C, respectively. The inner holding pieces 59 protrude from the inner circumferential side toward the outer circumferential side with respect to the curved portion 45C and hold the curved portion 45C from the front side.

The outer holding pieces 58 are provided such that the detection wire 45 is less likely to be out of the housing portion when the detection wire 45 is disposed away from the corner portion 57B and closer to the outer circumferential side due to the reaction force created in the detection wire 45 having the extra length portion. The inner holding pieces 59 are provided such that the detection wire 45 is less likely to be out of the housing portion when the detection wire 45 is pulled at the time of fitting of the connector 48 to a target connector or when the detection wire 45 having no extra length portion is disposed near the corner portion 57B and closer to the inner circumferential side.

More in detail, the pair of outer holding pieces 58 include the outer holding piece 58 that protrudes downward from the upper one of the right third side walls 57A of the third housing portion 57 and the outer holding piece 58 that protrudes rightward from the left one of the lower third side walls 57A. On the other hand, the pair of inner holding pieces 59 include the inner holding piece 59 that protrudes upward from the lower one of the right third side walls 57A of the third housing portion 57 and the inner holding piece 59 that protrudes leftward from the right one of the lower third side walls 57A.

The pair of outer holding pieces 58 have a protrusion dimension that is smaller than the protrusion dimension of the pair of inner holding pieces 59. The detection wire 45 is normally routed in the routing recess portion 50A with having an extra length portion. Therefore, the two end portions of the curved portion 45C are disposed behind the outer holding pieces 58 due to the reaction force and are held by the outer holding pieces 58 from the front side.

The first housing portion 55 includes a pair of first side walls 55A that are, respectively, continuous to lower ends of the pair of third side walls 57A that are on the lower end side of the third housing portion 57. A pair of first holding pieces 61 are on the pair of first side walls 55A so as to be opposite each other. The first holding pieces 61 hold the first wire portion 45A. The first holding piece 61 on the left side protrudes rightward from the left first side wall 55A and the first holding piece 61 on the right side protrudes leftward from the right first side wall 55A.

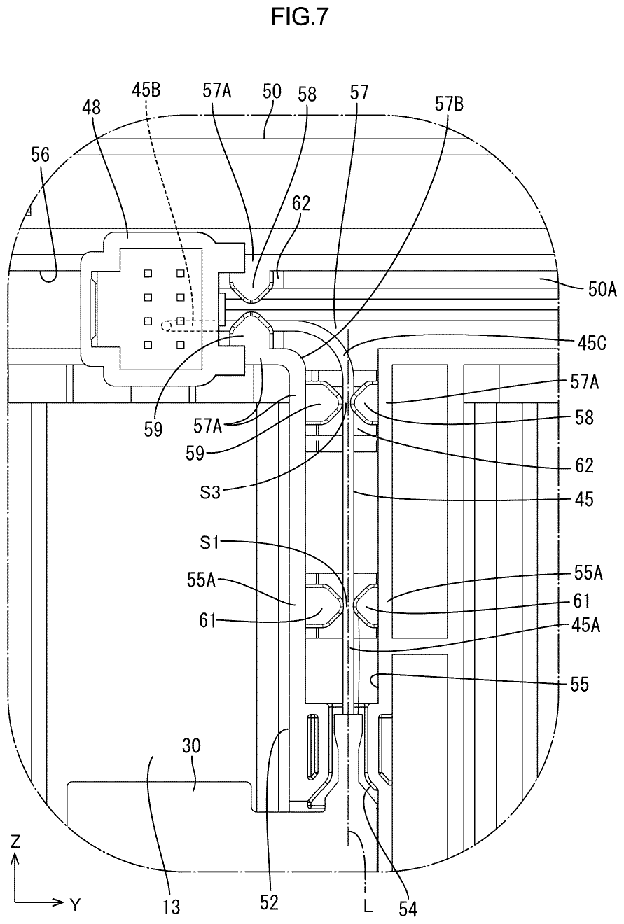

A space is between the outer holding piece 58 and the inner holding piece 59 that are on the lower end side of the third housing portion 57 and opposite each other and the space is defined as a third space S3. A space between the pair of first holding pieces 61 is defined as a first space S1. As illustrated in FIG. 7, the first space S1 and the third space S3 have a substantially same dimension and are on a same straight line L extending in the upper-bottom direction. With the first space S1 and the third space S3 being provided as described above, the detection wire 45 can be arranged in the routing recess portion 50A with the detection wire 45 extending straight. Therefore, the routing operation can be performed easily and workability is improved.

The first holding pieces 61 have distal ends having a mountain shape. The first space S1 is formed between the distal ends of the first holding pieces 61 and is a smallest space between the first holding pieces 61. The third space S3 is formed between a distal end of the outer holding piece 58 and a distal end of the inner holding piece 59 on the lower end side of the third housing portion 57 and is a smallest space between the outer holding piece 58 and the inner holding piece 59. When the detection wire 45 is routed in the routing recess portion 50A, it is most difficult to insert the detection wire 45 through the smallest space; however, with the above configuration, the smallest space has a shortest dimension in the upper-bottom direction, and therefore, the routing workability of the detection wire 45 is further improved.

### Arrangement of Inner Holding Pieces

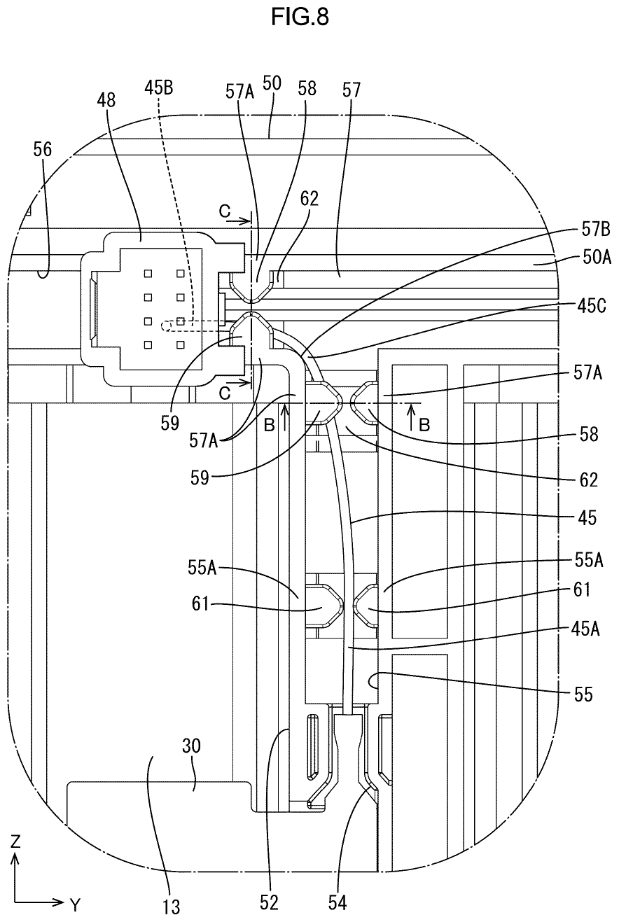

Next, the arrangement of the inner holding pieces 59 will be described with reference to FIGS. 8 to 11. The pair of inner holding piece 59 is in a closest position that is closest to the corner portion 57B of the third housing portion 57. Removal holes 62 are behind the outer holding pieces 58 and the inner holding pieces 59. Molding dies for molding the outer holding pieces 58 and the inner holding pieces 59 are removed through the removal holes 62. As the pair of inner holding pieces 59 are provided closer to the corner portion 57B with considering manufacturing tolerances, an area between the pair of removal holes 62 becomes smaller. This lowers strength of a bottom portion of the third housing portion 57. Therefore, the closest position previously described is a position in which the pair of inner holding pieces 59 can be provided closest to the corner portion 57B without causing the problem of lowering of the strength.

As illustrated in FIG. 8, with the detection wire 45 being strongly pulled when the connector 48 is fitted to a target connector, the detection wire 45 is arranged with a shortest route. If the pair of inner holding pieces 59 are not arranged in the closest position, the detection wire 45 may be out of the third housing portion 57 frontward near the corner portion 57B. In this respect, the pair of inner holding pieces 59 are arranged in the closest position in this embodiment. Therefore, with the detection wire 45 being arranged with the shortest route, the detection wire 45 is arranged behind the pair of inner holding pieces 59. Accordingly, the detection wire 45 is surely held by the pair of inner holding pieces 59 from the front side.

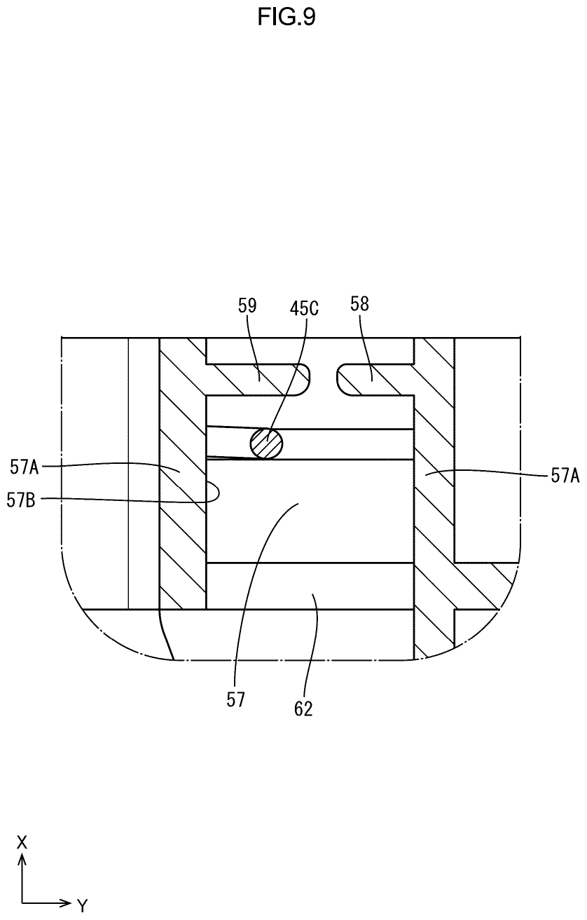

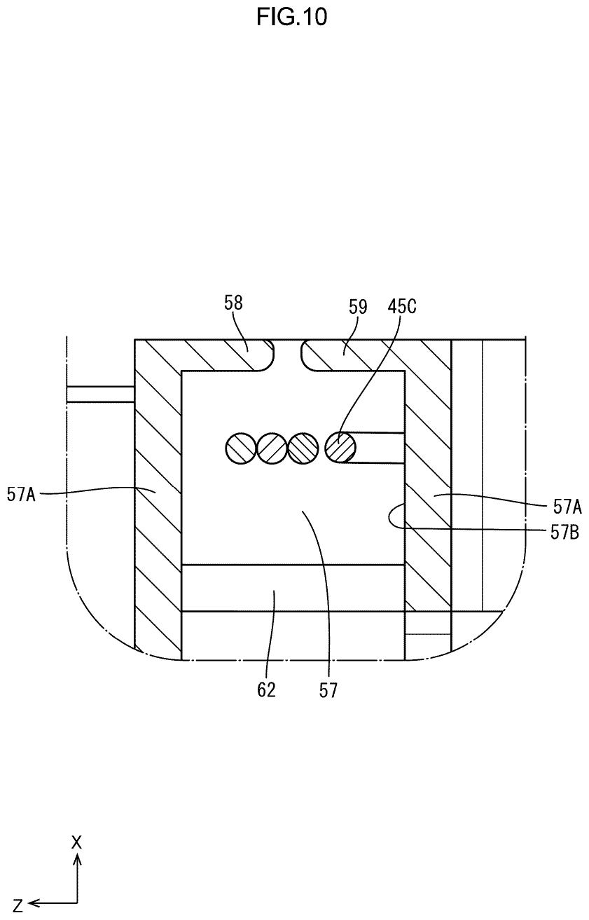

The curved portion 45C of the detection wire 45 is behind the inner holding piece 59 in a lower end portion of the third housing portion 57 illustrated in FIG. 9. With such a configuration, the curved portion 45C is less likely to be out of the third housing portion 57 frontward. Similarly, the curved portion 45C of the detection wire 45 is behind the inner holding piece 59 in a right end portion of the third housing portion 57 illustrated in FIG. 10. With such a configuration, the curved portion 45C is less likely to be out of the third housing portion 57 frontward. A space dimension of the smallest space that is between the distal end of the outer holding piece 58 and the distal end of the inner holding piece 59 is same as or smaller than the outer diameter of the detection wire 45. Therefore, the detection wire 45 is less likely to be out of the routing recess portion 50A via the smallest space.

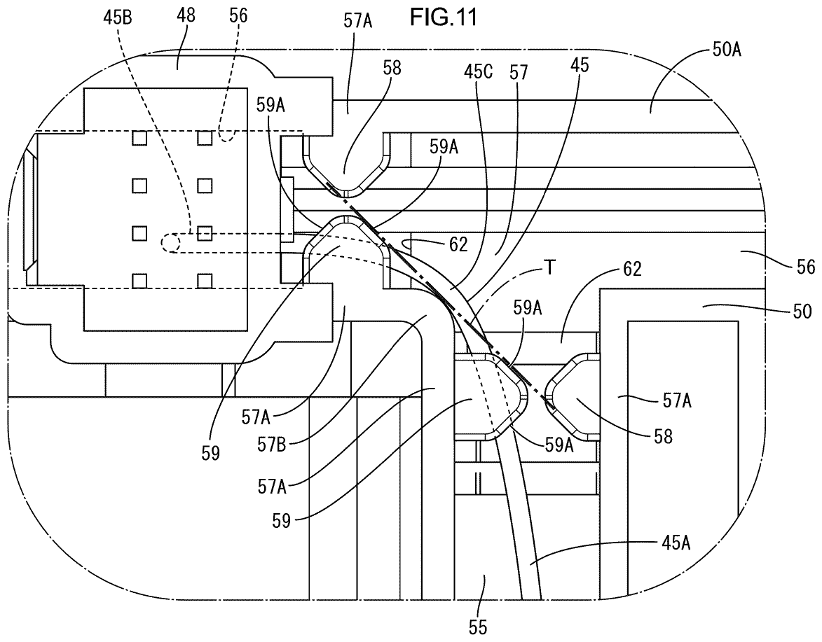

The reason why the detection wire 45 can be surely held by the pair of inner holding pieces 59 when the detection wire 45 is disposed in the shortest route will be described with reference to FIG. 11. First, a tangent line T to the corner portion 57B is drawn at an angle of 45° with respect to the third side wall 57A. The tangent line T is a tangent line T to the corner portion 57B and the angle formed between the tangent line T and each of the third side walls 57A on the lower end side and the right end side of the third housing portion 57 is 45°. Each of the inner holding pieces 59 protrudes from the third side wall 57A on the inner circumferential side to the tangent line T. Each inner holding piece 59 has a pair of oblique sides 59A at a distal end thereof. One of the oblique sides 59A of each inner holding piece 59 that is closer to the corner portion 57B extends along the tangent line T.

With the detection wire 45 being in a shortest route, the detection wire 45 is routed on an inner circumferential side with respect to the tangent line T at the positions of the inner holding pieces 59. Therefore, with the inner holding pieces 59 protruding to the tangent line T, the detection wire 45 is surely disposed behind the inner holding pieces 59. Therefore, the detection wire 45 is held by the pair of inner holding pieces 59 in two end portions of the third housing portion 57 and the detection wire 45 is less likely to be out of the housing portion frontward at the corner portion 57B.

### Operations and Effects of Embodiment

According to the embodiment, operations and effects described below are obtained.

The wiring module 20 according to the embodiment is to be coupled to the battery stack member 11L including the laminated type batteries 11 that are arranged. Each of the laminated type batteries 11 includes a pair of electrode leads 12. The wiring module 20 includes the detection terminals 30 that are connected to the electrode leads 12, the detection wires 45, the first housing portion 55, the second housing portion 56, the third housing portion 57, and a pair of outer holding pieces 58, and a pair of inner holding pieces 59. The detection wire 45 includes the first wire portion 45A, the second wire portion 45B, and the curved portion 45C. The first wire portion 45A is connected to the detection terminal 30 and extends in the upper-bottom direction. The second wire portion 45B extends in the right-left direction. The curved portion 45C connects the first wire portion 45A and the second wire portion 45B and is curved from the upper-bottom direction toward the right-left direction. The first wire portion 45A is arranged in the first housing portion 55, the second wire portion 45B is arranged in the second housing portion 56, and the curved portion 45C is arranged in the third housing portion 57. The third housing portion 57 includes the corner portion 57B on an inner circumferential side with respect to the curved portion 45C. The third housing portion 57 connects the first housing portion 55 and the second housing portion 56. The third housing portion 57 has an L-shape. The pair of outer holding pieces 58 are provided corresponding to the two end portions of the curved portion 45C, respectively. The outer holding pieces 58 protrude from the outer circumferential side toward the inner circumferential side with respect to the curved portion 45C and hold the curved portion 45C. The pair of inner holding pieces 59 are provided corresponding to the two end portions of the curved portion 45C, respectively. The inner holding pieces 59 protrude from the inner circumferential side toward the outer circumferential side with respect to the curved portion 45C and hold the curved portion 45C. The pair of third side walls 57A are configured as the two side portions of the third housing portion 57. The pair of inner holding pieces 59 protrude from one of the third side walls 57A on the inner circumferential side to the tangent line T extending with respect to the corner portion 57B at the angle of 45° with respect to the third side wall 57A.

The detection wire 45 extends from the first housing portion 55 to the second housing portion 56 via the third housing portion 57 and the curved portion 45C is curved along the third side wall 57A on the outer circumferential side from the upper-bottom direction to the right-left direction due to a reaction force created in the curved portion 45C. However, the curved portion 45C of the detection wire 45 may be out of the third housing portion 57 due to the reaction force. With the wiring module 20 including the pair of outer holding pieces 58 corresponding to the two end portions of the curved portion 45C, respectively, the curved portion 45C of the detection wire 45 is less likely to be out of the housing portion.

The connector 48 is provided on other end of the two ends of the detection wire 45 that is an opposite end side from the detection terminal 30. When the detection wire 45 is strongly pulled at the time of fitting of the connector 48 to a target connector, the curved portion 45C of the detection wire 45 is curved along the corner portion 57B of the third housing portion 57 and the detection wire 45 is arranged with a shortest route. In this respect, the pair of inner holding pieces 59 are provided corresponding to the two end portions of the curved portion 45C, respectively. The pair of third side walls 57A are configured as the two side portions of the third housing portion 57. The pair of inner holding pieces 59 protrude from one of the third side walls 57A on the inner circumferential side to the tangent line T extending with respect to the corner portion 57B at the angle of 45° with respect to the third side walls 57A. With such a configuration, the curved portion 45C of the detection wire 45 is less likely to be out of the housing portion.

In the embodiment, the first housing portion 55 includes a pair of first side walls 55A that are, respectively, continuous to the pair of third side walls 57A. The pair of first holding pieces 61 are on the pair of first side walls 55A so as to be opposite each other. The first holding pieces 61 hold the first wire portion 45A. The third space S3 formed between the outer holding piece 58 and the inner holding piece 59 that are on the first housing portion 55 side in the third housing portion 57 and opposite each other and the first space S1 between the pair of first holding pieces 61 have a same dimension and are on a same straight line L extending in the upper-bottom direction.

With the third space S3 and the first space S1 having the same dimension and being on the same straight line L, the detection wire 45 can be arranged and routed in the first housing portion 55 and the third housing portion 57 with the detection wire 45 extending straight in the upper-bottom direction. Therefore, the routing operation of the detection wire 45 can be improved.

In the embodiment, the distal ends of the first holding pieces 61 have a mountain shape. The first space S1 is formed between the distal ends of the first holding pieces 61 and is a smallest space between the first holding pieces 61. The distal end of the outer holding piece 58 and the distal end of the inner holding piece 59 have a mountain shape. The third space S3 is formed between the distal end of the outer holding piece 58 and the distal end of the inner holding piece 59 on the first housing portion 55 side of the third housing portion 57 and is a smallest space between the outer holding piece 58 and the inner holding piece 59.

With the distal end of the outer holding piece 58 and the distal end of the inner holding piece 59 having a mountain shape, the smallest space through which the detection wire 45 hardly passes becomes smaller and therefore, the workability of routing the detection wire 45 is further improved.

### Other Embodiments

(1) In the above embodiment, the detection terminal 30 is directly connected to the connection portion 13 (the connection electrode lead 12A) ; however, the detection terminal 30 may be connected to the connection portion 13 (the connection electrode lead 12A) via a connection member such as a busbar.

(2) In the above embodiment, the pair of first holding pieces 61 are provided in one portion; however, pairs of first holding pieces 61 may be provided in multiple portions.

(3) In the above embodiment, the distal ends of the outer holding pieces 58 and the distal ends of the inner holding pieces 59 and the distal ends of the first holding pieces 61 have a mountain shape; however, they may not have the mountain shape but may have a circular arched shape or a flat shape extending the upper-bottom direction.

(4) In the above embodiment, the four electrode leads 12 are connected and configured as the connection portion 13; however, the configuration is not limited to the above one as long as the connection portion is configured by connecting multiple electrode leads.

### EXPLANATION OF SYMBOLS

10: Battery module
11: Laminated type battery (battery)
11L: Battery stuck member (battery group)
12: Electrode lead (electrode)
12A: Connection electrode lead
12B: Output electrode lead
13: Connection portion
15: Casing
15A: Bottom portion
15B: Ceiling portion
15C: Side portion
20: Wiring module
30: Detection terminal
31: Body portion
32: Connection portion
34: Wire joint portion
40: Busbar
40A: First portion
40B: Second portion
41: Busbar side connection portion
41A: Through hole
45: Detection wire
45A: First wire portion
45B: Second wire portion
45C: Curved portion
48: Connector
48A: Housing
48B: Male terminal
50: Protector
50A: Routing recess portion
51: Protector body
52: Electrode housing recess portion
52A: Connection electrode housing recess portion
52B: Output electrode housing recess portion
53: Busbar holding portion
53A: Bolt fixing portion
54: Terminal housing portion
54A: Terminal holding portion
55: First housing portion
55A: First side wall
56: Second housing portion
56: Second housing portion
57: Third housing portion
57A: Third side wall
57B: Corner portion
58: Outer holding piece
59: Inner holding piece
59A: Oblique side
60: Tangent line
61: First holding piece
62: Removal hole
L: straight line
S1: First space
S3: Third space
T: Tangent line

1. A wiring module to be coupled to a battery group including batteries each of which has a pair of electrodes and that are arranged, the wiring module comprising:
detection terminals that are connected to the electrodes or connected to the electrodes via a connection member;
detection wires each of which includes a first wire portion that is connected to one of the detection terminals and extends in a vertical direction perpendicular to an arrangement direction in which the batteries are arranged, a second wire portion that extends in the arrangement direction in which the batteries are arranged, and a curved portion that connects the first wire portion and the second wire portion and is curved from the vertical direction to the arrangement direction;
a first housing portion in which the first wire portion is arranged;
a second housing portion in which the second wire portion is arranged;
a third housing portion in which the curved portion is arranged and that includes a corner portion on an inner circumferential side with respect to the curved portion and connects the first housing portion and the second housing portion and has an L-shape and includes a pair of third side walls on two sides of the third housing portion;
a pair of outer holding pieces provided corresponding to two end portions of the curved portion, respectively, the pair of outer holding pieces protruding from an outer circumferential side toward the inner circumferential side with respect to the curved portion and holding the curved portion; and
a pair of inner holding pieces provided corresponding to the two end portions of the curved portion, respectively, the inner holding pieces protruding from the inner circumferential side toward the outer circumferential side with respect to the curved portion and holding the curved portion, wherein
the pair of inner holding pieces at least protrude from one of the pair of third side walls of the third housing portion that is on the inner circumferential side to a tangent line with respect to the corner portion, the tangent line extending at an angle of 45° with respect to the one of the pair of third side walls.

2. The wiring module according to claim 1, wherein
the first housing portion includes a pair of first side walls that are, respectively, continuous to the pair of third side walls,
a pair of first holding pieces are on the pair of first side walls so as to be opposite each other and the pair of first holding pieces hold the first wire portion, and
a third space formed between one of the pair of outer holding pieces and one of the pair of inner holding pieces that are close to the first housing portion in the third housing portion and are opposite each other and a first space between the pair of first holding pieces have a same dimension and are on a same straight line extending in the vertical direction.

3. The wiring module according to claim 2, wherein
the pair of first holding pieces have distal ends having a mountain shape and the first space is formed between the distal ends of the pair of first holding pieces and the first space is a smallest space between the pair of first holding pieces, and
the distal end of the one of the pair of outer holding pieces and the distal end of the one of the pair of inner holding pieces have a mountain shape and the third space is formed between the distal end of the one of the pair of outer holding pieces and the distal end of the one of the pair of inner holding pieces close to the first housing portion in the third housing portion and the third space is a smallest space between the distal ends of the one of the pair of outer holding pieces and the one of the pair of inner holding pieces.
